(19) United States
(12) Patent Application Publication
(10) Pub. No.: US 2017/0245181 A1
(43) Pub. Date: Aug. 24, 2017

(54) APPARATUS FOR DUAL CONNECTIVITY

(71) Applicant: NEC Corporation, Tokyo (JP)

(72) Inventors: Xiaowei ZHANG, Tokyo (JP); Andreas KUNZ, Heidelberg (DE); Anand Raghawa PRASAD, Tokyo (JP)

(73) Assignee: NEC Corporation, Tokyo (JP)

(21) Appl. No.: 15/512,204

(22) PCT Filed: Sep. 16, 2015
(86) PCT No.: PCT/JP2015/004734

§ 371 Date: Mar. 17, 2017

(30) Foreign Application Priority Data
Sep. 19, 2014 (JP) 2014-191573

(51) Int. Cl. H04W 36/00; H04W 12/08; H04W 36/08; H04W 12/06; H04W 76/04; H04W 12/04

(52) U.S. Cl. CPC H04W 36/0038; H04W 76/046; H04W 36/0055; H04W 12/04; H04W 36/08; H04W 12/06; H04W 12/08; H04W 88/06

(57) ABSTRACT

Upon requesting an MME (40) to handover a UE (10) to a Target MeNB (20_2), a Source MeNB (20_1) sends, to the Target MeNB (20_2) through the MME (40), information on one or more SeNBs that are candidates available for dual connectivity under control of the Target MeNB (20_2). The Target MeNB (20_2) configures a Target SeNB (30_2) that is selected based on the information to provide the dual connectivity. Alternatively, the Source MeNB (20_1) sends, to the Target MeNB (20_2), information on a Source SeNB (30_1) that has been used by the Source MeNB (20_1) for the dual connectivity. In this case, the Target MeNB (20_2) skips RRC configuration for the Source SeNB (30_1) upon the control.

### TECHNICAL FIELD

The present invention relates to an apparatus for DC (Dual Connectivity), and particularly to a technique for handover between mobile network cells considering dual connectivity to small cells.

### BACKGROUND ART

Currently, 3GPP (3rd Generation Partnership Project) has provided some conclusions on how to add or release small cells for two selected architectures Alternative 1A and Alternative 3C as disclosed in NPL 1.

The architecture Alternative 1A is the combination of S1-U that terminates in an SeNB (Secondary eNB (evolved Node B)), and independent PDCPs (Packet Data Convergence Protocols) (i.e., no bearer split). On the other hand, the architecture Alternative 3C is the combination of S1-U that terminates in an MeNB (Master eNB), bearer split in the MeNB, and independent RLCs (Radio Link Controls) for split bearers. Note that the S1-U is an interface for U-Plane (User-Plane) communication between the eNB and an S-GW (Serving Gateway).

### CITATION LIST

### Non Patent Literature

NPL 1: 3GPP TR 36.842, “Study on Small Cell enhancements for E-UTRA and E-UTRAN; Higher layer aspects (Release 12)”, V12.0.0, 2013-12, clauses 8.1.1.1 and 8.1.1.8, pp. 38-39 and 42

### SUMMARY OF INVENTION

### Technical Problem

However, the inventors of this application have found that some aspects are still missing in 3GPP, e.g., the handover between two MeNBs in addition to change of SeNB at the same time. There are problems on security, admission control and handover execution for handovers between mobile network cells considering dual connectivity to small cells at the same time.

Specifically, the following three scenarios can be considered:

1) Scenario 1: handover of the MeNB and SeNB DRBs (Data Radio Bearers) at the same time, when the target SeNB is different from the source SeNB;

2) Scenario 2: handover to target MeNB while a UE (User Equipment) connection remains at an SeNB, when the target SeNB is the same as the source SeNB; and

3) Scenario 3: release the current SeNB during handover to the target MeNB, and configure a new SeNB after the handover is successfully completed, in which the target and source SeNBs may or may not be the same node.

For example, in the scenario 1, especially for the architecture Alternative 1A, the UE has at least two simultaneously ongoing bearers, i.e., at least one towards the MeNB and at least one to the SeNB at the same time (dual connectivity).

In all of the scenarios 1 to 3, there are the following problems that need to be solved:

Security key derivation during handover;

Inform the UE and the S-GW to stop sending packets via the SeNB; and

Inform an MME (Mobility Management Entity) and the S-GW that new Target SeNB is configured.

Note that details of each scenario and each problem, and other problems will become apparent below.

Accordingly, an exemplary object of the present invention is to provide a solution for solving at least one of these problems.

### Solution to Problem

In order to achieve the above-mentioned object, a UE according to first exemplary aspect of the present invention includes: first means for receiving, from an MME through an MeNB to which the UE currently attaches for dual connectivity, a command to handover the UE to a different MeNB; and second means for deriving, by use of parameters included in the command, a security key that is used for securely communicating for the dual connectivity with an SeNB under control of the different MeNB.

Further, an MeNB according to second exemplary aspect of the present invention controls an SeNB to provide dual connectivity for a UE. This MeNB includes: first means for sending to an MME, upon requesting the MME to handover the UE to a different MeNB, first information on one or more SeNBs that are candidates available for the dual connectivity under control of the different MeNB.

Further, an MeNB according to third exemplary aspect of the present invention controls an SeNB to provide dual connectivity for a UE. This MeNB includes: first means for sending to an MME, upon requesting the MME to handover the UE to a different MeNB, information on the SeNB being available for the dual connectivity under control of the different MeNB.

Further, an MeNB according to fourth exemplary aspect of the present invention includes: first means for receiving from an MME, upon being requested by the MME to handover a UE from a different MeNB to the MeNB itself, first information on one or more SeNBs that are candidates available for providing dual connectivity for the UE; and second means for configuring a SeNB that is selected based on the first information to provide the dual connectivity.

Further, an MeNB according to fifth exemplary aspect of the present invention includes: first means for receiving from an MME, upon being requested by the MME to handover a UE from a different MeNB to the MeNB itself, first information on an SeNB that has been used by the different MeNB for providing dual connectivity for the UE; and second means for configuring the SeNB to provide the dual connectivity. The second means is configured to skip, upon the configuration, RRC (Radio Resource Control) configuration to the SeNB.

Further, an MME according to sixth exemplary aspect of the present invention includes: first means for forwarding to an MeNB, upon requesting the MeNB to handover a UE from a different MeNB to the MeNB, first information on one or more SeNBs that are candidates available for providing dual connectivity for the UE.

Furthermore, an MME according to seventh exemplary aspect of the present invention includes: first means for forwarding to an MeNB, upon requesting the MeNB to handover a UE from a different MeNB to the MeNB, first information on an SeNB that has been used by the different MeNB for providing dual connectivity for the UE.

### Advantageous Effects of Invention

According to the present invention, it is possible to solve at least one of the above-mentioned problems on security, admission control and handover execution for handovers between mobile network cells considering dual connectivity to small cells at the same time.

### BRIEF DESCRIPTION OF DRAWINGS

FIG. 1 is a block diagram showing a configuration example of a system according to a first exemplary embodiment of the present invention.

FIG. 2 is a block diagram showing a scenario treated in the first exemplary embodiment.

FIG. 3 is a sequence diagram showing a part of operation examples in the first exemplary embodiment.

FIG. 4 is a sequence diagram showing the remaining part of operation examples in the first exemplary embodiment.

FIG. 5 is a block diagram showing a scenario treated in a second exemplary embodiment of the present invention.

FIG. 6 is a block diagram showing a configuration example of a system according to the second exemplary embodiment.

FIG. 7 is a sequence diagram showing a part of operation examples in the second exemplary embodiment.

FIG. 8 is a sequence diagram showing the remaining part of operation examples in the second exemplary embodiment.

FIG. 9 is a sequence diagram showing operation examples in a third exemplary embodiment of the present invention.

FIG. 10 is a block diagram showing a configuration example of a UE common to the first to third exemplary embodiments.

FIG. 11 is a block diagram showing one configuration example of an MeNB common to the first to third exemplary embodiments.

FIG. 12 is a block diagram showing another configuration example of the MeNB common to the first to third exemplary embodiments.

FIG. 13 is a block diagram showing a configuration example of an MME common to the first to third exemplary embodiments.

### DESCRIPTION OF EMBODIMENTS

Hereinafter, first to third exemplary embodiments of apparatuses according to the present invention will be described with the accompanying drawings.

### First Exemplary Embodiment

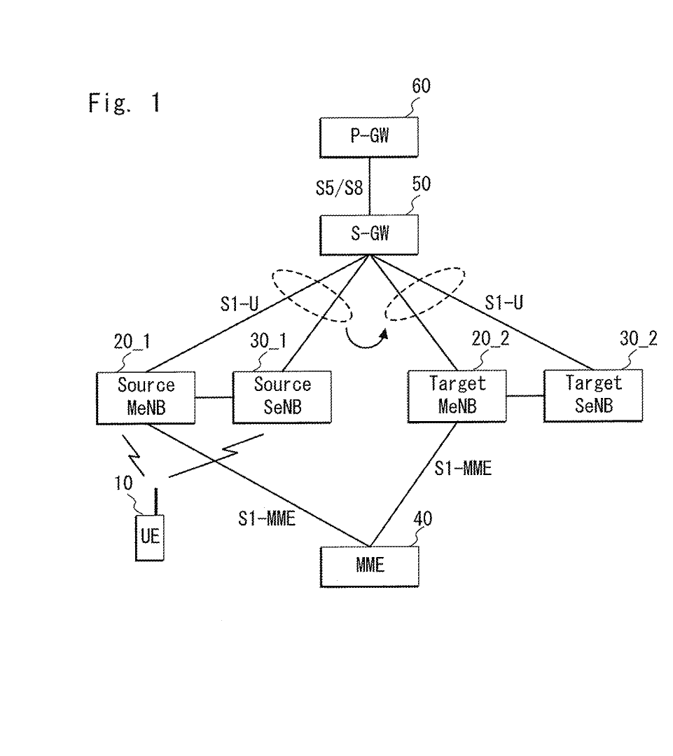

As shown in FIG. 1, a system according to this exemplary embodiment includes a UE 10, MeNBs 20_1 and 20_2, SeNBs 30_1 and 30_2, an MME 40, an S-GW50, and a P-GW (PDN (Public Data Network) Gateway) 60.

There are provided S1-MME interfaces for C-Plane (Control-Plane) signaling between the MME 40, and the respective MeNB 20_1 and 20_2. The C-Plane interface does not exist between the MME 40, and each of the SeNBs 30_1 and 30_2. Moreover, the C-Plane interface does not exist between the UE 10, and each of the SeNBs 30_1 and 30_2. Therefore, under control of each of the MeNB 20_1 and 20_2, each of the SeNBs 30_1 and 30_2 wirelessly communicates with the UE 10.

Further, there are also provided S1-U interfaces for U-Plane communication between the S-GW 50, and the respective MeNBs 20_1, 20_2 and SeNBs 30_1 and 30_2. In this system, U-Plane traffic between the UE 10 and the S-GW 50 is transmitted through the MeNB (20_1 or 20_2) and the SeNB (30_1 or 30_2) in parallel for the purpose of offloading the MeNB (in other words, for the purpose of offloading the backhaul interface between the MeNB and the S-GW).

Furthermore, the S-GW50 is connected to the P-GW 60 through interfaces S5 and/or S8.

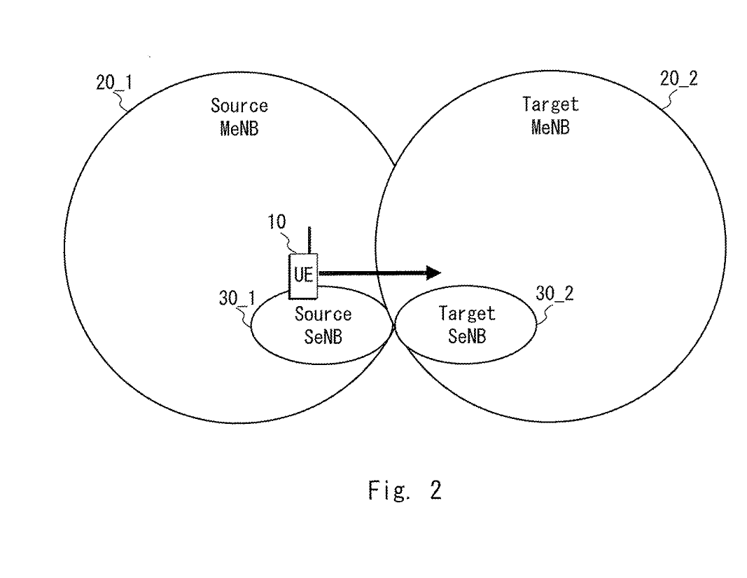

Generally, this exemplary embodiment treats the above-mentioned scenario 1. Specifically, as shown in FIG. 2, it is assumed that the UE 10 currently attaches to the MeNB 20_1, the MeNB 20_1 and the SeNB 30_1 provide dual connectivity for the UE 10, and then the UE 10 is handed-over to the MeNB 20_2, so that the MeNB 20_2 and the SeNB 30_2 alternatively provide the dual connectivity. Note that in the following description, the MeNB from which the UE is handed-over will be sometimes referred to as “Source MeNB” or simply to as “MeNB”, and the SeNB controlled by the Source MeNB will be sometimes referred to as “Source SeNB” or simply to as “SeNB”. On the other hand, the MeNB to which the UE is handed-over will be sometimes referred to as “Target MeNB” or “M′eNB”, and the SeNB controlled by the Target MeNB will be sometimes referred to as “Target SeNB” or simply to as “S′eNB”.

If the UE 10 would perform a handover to the Target MeNB 20_2 and SeNB 30_2, then all S1 bearers and radio bearers would have to be handed-over to the corresponding target cells as by dotted lines in FIG. 1.

For simplicity, it is assumed that all cells are served by the same MME (pool) and the same S-GW (pool).

In this scenario, the following matters (1) to (4) will be required.

(1) The MeNB should determine whether an S′eNB is available, otherwise it handovers all existing bearers to the Target MeNB.

(2) If the S′eNB is available for the given UE, the Target MeNB should complete S′eNB configuration before handover the bearers to the Target MeNB.

(3) The S-GW and UE should be informed for SeNB change.

(4) Handover procedure should be updated accordingly.

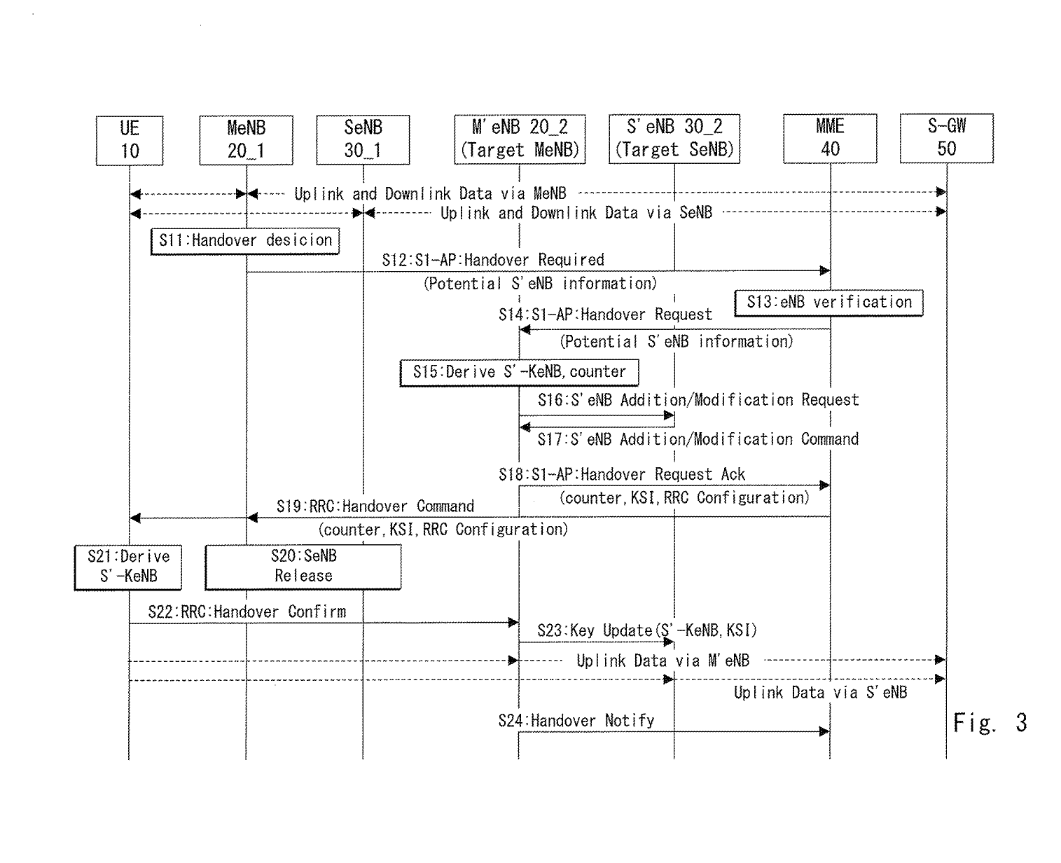

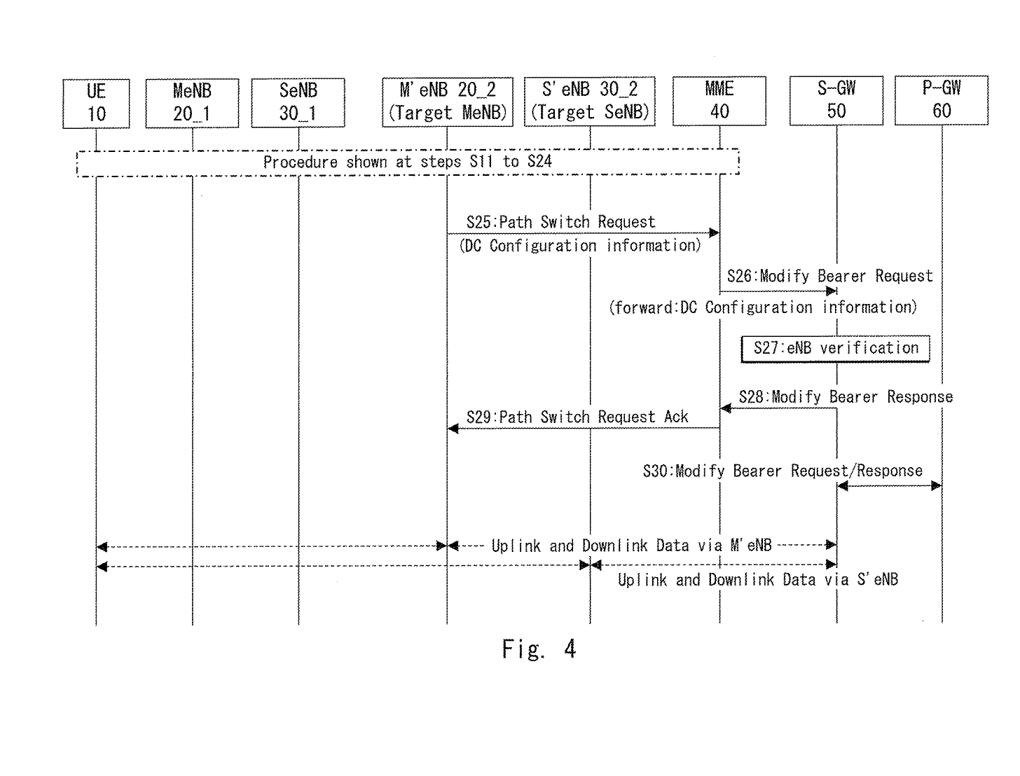

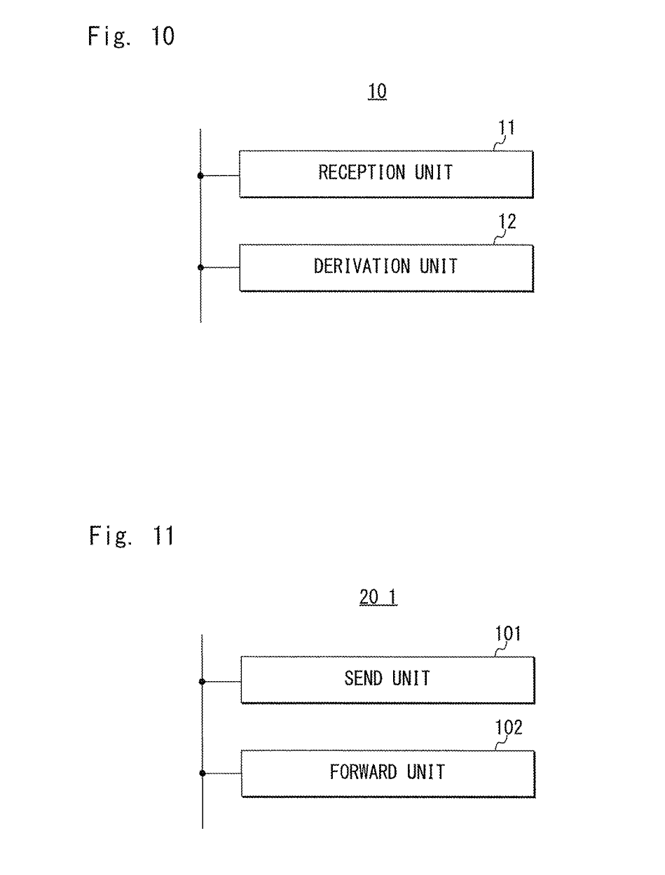

Next, there will be described operation examples of this exemplary embodiment with reference to FIGS. 3 and 4. Note that procedures in this exemplary embodiment as well as second and third exemplary embodiments are based on Inter-eNB handover initiated via an S1 interface (see e.g., 3GPP TS 23.401 about the details of a typical Inter-eNB handover). Meanwhile, configuration examples of the UE 10, the Source MeNB 20_1, the Target MeNB 20_2 and the MME 40 will be described later with reference to FIGS. 10 to 13.

As shown in FIG. 3, the MeNB 20_1 makes decision for the handover (step S11), and if available, includes information (hereinafter, sometimes referred to as “Potential S′eNB information”) on the SeNB 30_1 and the S′eNB 30_2 in a Handover Required message to be transmitted to the MME 40 (step S12).

For example, the Potential S′eNB information includes IP (Internet Protocol) addresses, identities, TEIDs (Tunnel Endpoint Identifiers), EPC (Evolved Packet Core) Bearers IDs and/or the like, which are allocated to one or more SeNBs that are candidates available for the dual connectivity under control of the M′eNB 20_2. The MeNB 20_1 can determine such candidates based on a Measurement Report originated from the UE 10, for example.

The Handover Required message is one of messages defined in S1-AP (S1 Application Protocol). Meanwhile, in this exemplary embodiment, the Handover Required message is modified to include information of which SeNB may be the potential S′eNB (new SeNB) that M′eNB (Target MeNB) can configure for the given UE. The Source MeNB 20_1 indicates what bearers are currently served by the Source SeNB 30_1. The MeNB 20_1 may send the SeNB ID and TEIDs in a case where the SeNB 30_1 is served by several MeNBs to avoid unnecessary release/addition of the SeNB bearers.

Note that in the following description, the message defined in the S1-AP will be sometimes denoted as “S1-AP: XXX (XXX is arbitrary message name)”. Moreover, a message defined in RRC (Radio Resource Control) protocol will be sometimes denoted as “RRC: XXX”.

Upon receiving the S1-AP: Handover Required message, the MME 40 performs call admission control (step S13). At this step 513, the MME 40 verifies the Source MeNB 20_1 and SeNB 30_1 as well as the desired Target MeNB/SeNB. Based on the Potential S′eNB information given by the MeNB 20_1, the MME 40 may verify what kind of bearers are allowed to be offloaded to the SeNB e.g. based on the subscription profile, QoS (Quality of Service) and/or the like. Moreover, the MME 40 can verify whether the M′eNB 20_2 and/or the S′eNB 30_2 are allowed for the DC configuration.

Then, the MME 40 includes the Potential S′eNB information in an S1-AP: Handover Request message to be transmitted to the Target MeNB (M′eNB) 20_2 (step S14).

Upon receiving the S1-AP: Handover Request message, the M′eNB 20_2 selects the S′eNB 30_2 based on the Potential S′eNB, or confirms the S′eNB 30_2 proposed by the MME 40. Moreover, the M′eNB 20_2 derives a key S′-KeNB and a counter (step S15).

The key S′-KeNB is a security key which is used for conducting secure communication between the UE 10 and the S′eNB 30 2. The counter is used for the UE 10 to derive the same key S′-KeNB, and is used for the M′eNB 20_2 and the UE 10 to update the key S′-KeNB in synchronization with each other. Every time the key S′-KeNB is derived or updated, the counter will be incremented.

Further, the M′eNB 20_2 sends an S′eNB Addition/Modification Request message to the S′eNB 30_2 with the EPC Bearer IDs, QoS, QCIs (QoS Class Indicators) and/or the like (step S16). In response to this message, the S′eNB 30_2 sends an S′eNB Addition/Modification Command message back to the M′eNB 20_2 (step S17).

Then, the M′eNB 20_2 sends an S1-AP: Handover Request Ack (acknowledgement) message to the MME 40 (step S18). In this Handover Request Ack message, the M′eNB 20_2 provides the counter and a KSI (Key Set Identifier). The KSI indicates which master key (e.g., KeNB) has been used upon deriving the key S′-KeNB. Moreover, the M′eNB 20_2 also provides information (hereinafter, sometimes referred to as “RRC configuration information”) on RRC configuration for the S′eNB 30_2. The M′eNB 20_2 may provide information about the S′eNB 30_2, e.g., new C-RNTI (Cell Radio Network Temporary Identifier), target eNB security algorithm identifiers for the selected security algorithms, dedicated RACH (Random Access Channel) preamble, and possibly some other parameters, i.e., access parameters, SIBs (System Information Blocks), etc.

Upon receiving the S1-AP: Handover Request Ack message, the MME 40 forwards the above-mentioned necessary parameters for key derivation to the UE 10. Specifically, the MME 40 includes the counter and the KSI in an RRC: Handover Command message to be transmitted to the UE 10 through the MeNB 20_1 (step S19). In this exemplary embodiment, the Handover Command message is modified to include the counter and the KSI, such that the UE 10 can derive the same key S′-KeNB as that derived by the M′eNB 20_2.

Once the MeNB 20_1 receives the Handover Command message, the MeNB 20_1 sends an SeNB Release Request message to the SeNB 30_1 to remove the relationship to the SeNB 30_1 for the UE 10 (step S20).

On the other hand, since the UE 10 is handed-over to the M′eNB 20_2 and the S′eNB 30_2, new K-eNB and new S-KeNB should be derived and in use. Therefore, the UE 10 derives the key S′-KeNB by using the received counter and KSI (step S21). Then, the UE 10 sends to the M′eNB 20_2 an RRC: Handover Confirm message indicating that the UE 10 tuned to the M′eNB 20_2 (step S22).

Upon receiving the RRC: Handover Confirm message, the M′eNB 20_2 sends to the S′eNB 30_2 a Key Update message including the key S′-KeNB and the KSI (step S23). Moreover, the M′eNB 20_2 sends a Handover Notify message to the MME 40 (step S24).

Thus, uplink data from the UE 10 to the S-GW 50 can be transmitted through the M′eNB 20_2 and the S′eNB 30_2 in parallel.

The UE 10 has now synchronized with the M′eNB 20_2 and the S′eNB 30_2. Therefore, as shown in FIG. 4, the M′eNB 20_2 sends a Path Switch Request message to the MME 40 (step S25). In this exemplary embodiment, the Path Switch Request message is modified to include DC configuration information containing e.g., the configured DRB information, SeNB ID and SeNB IP address, thereby requesting for the bearers that should be handed-over to the M′eNB 20 2 as well as for the bearers that should be handed-over to the S′eNB 30 2.

The MME 40 forwards the DC configuration information in a Modify Bearer Request message to the S-GW 50 (step S26).

The GW 50 performs eNB verification (step S27) to:

1) verify whether the M′eNB 20_2 is allowed to configure the S′eNB 30_2 for the given UE 10;

2) verify whether the S′eNB 30_2 is a valid network element;

3) verify whether he S′eNB 30_2 is authorized to provide dual connectivity; and

4) confirm whether this request message is a DoS (Disc operating System) attack.

Upon succeeding in the verification, the S-GW 50 sends a Modify Bearer Response message back to the MME 40 (step S28). Then, the MME 40 sends a Path Switch Request Ack message back to the M′eNB 20_2 (step S29). Moreover, the S-GW 50 sends/receives Modify Bearer Request/Response messages to/from the P-GW 60 (step S30).

Thus, downlink data from the S-GW 50 to the UE 10 can also be transmitted through the M′eNB 20_2 and the S′eNB 30_2 in parallel.

As described above, in this exemplary embodiment, it is possible for the UE and the Target MeNB to derive the security key S′-KeNB during the handover procedure. Further, it is possible to inform the UE and the S-GW to stop sending packets via the source SeNB. Furthermore, it is possible to inform the MME and the S-GW that new Target SeNB is configured.

In addition, it is possible to quickly complete the configuration for the Target SeNB, compared with e.g., a case where after the handover procedure is completed, such a configuration is started in a similar manner to the typical initial SeNB configuration. Thus, according to this exemplary embodiment, it is also possible to greatly reduce the time when the U-Plane communication is disrupted due to inter-MeNB handover.

### Second Exemplary Embodiment

A system according to this exemplary embodiment can be configured in a similar manner to that shown in FIG. 1 in the first exemplary embodiment.

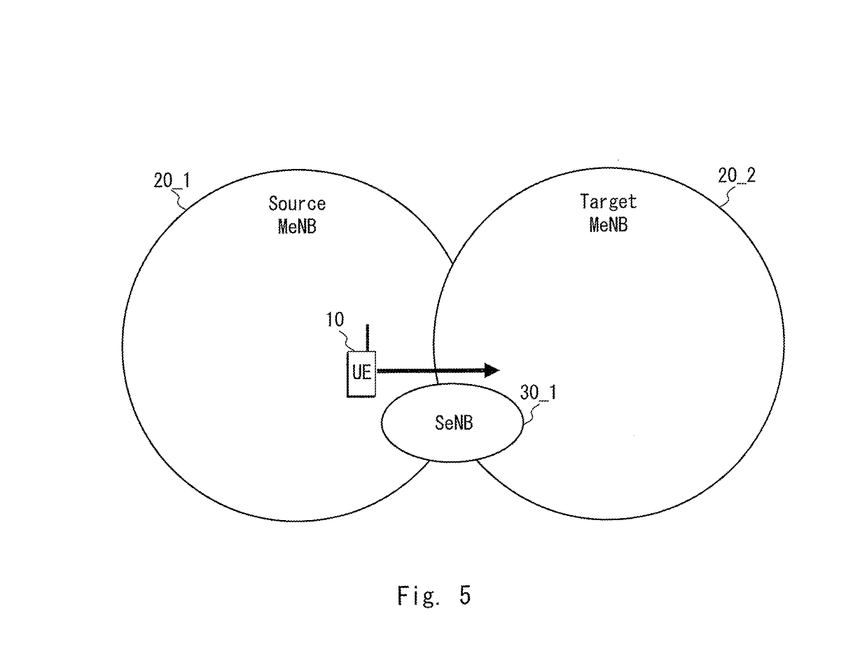

Meanwhile, this exemplary embodiment is different from the first exemplary embodiment in treating the above-mentioned scenario 2. Specifically, as shown in FIG. 5, the Source SeNB and the Target SeNB are the same SeNB 30_1, i.e., a cell formed by the SeNB 30_1 is shared by two MeNBs 20_1 and 20_2.

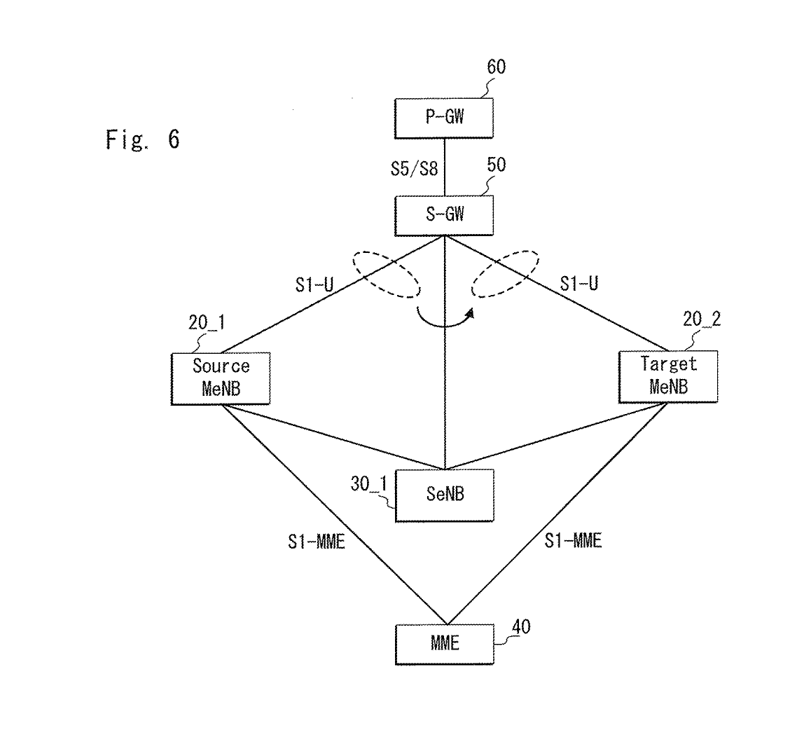

In this scenario, as shown by dotted lines in FIG. 6, it is beneficial to minimize the bearer handover to the ones that are residing at the MeNBs 20_1 and 20_2. In other words, the current procedures would also release the SeNB and the try to add the bearers after the MeNB handover again at the same SeNB.

Therefore, in this exemplary embodiment, the following matters (1) to (5) will be required.

(1) The Target MeNB has knowledge that the current SeNB is the best candidates available for dual connectivity for the given UE, or the Target MeNB has already configured the same SeNB which can provide dual connectivity for the given UE.

(2) The MeNB should not handover the SeNB DRBs.

(3) The security in the SeNB should be updated especially when there is no explicit SeNB Addition to trigger the Target MeNB to send key to the SeNB.

(4) The SGW and the UE are informed for such change.

(5) Handover procedure should be updated to accordingly.

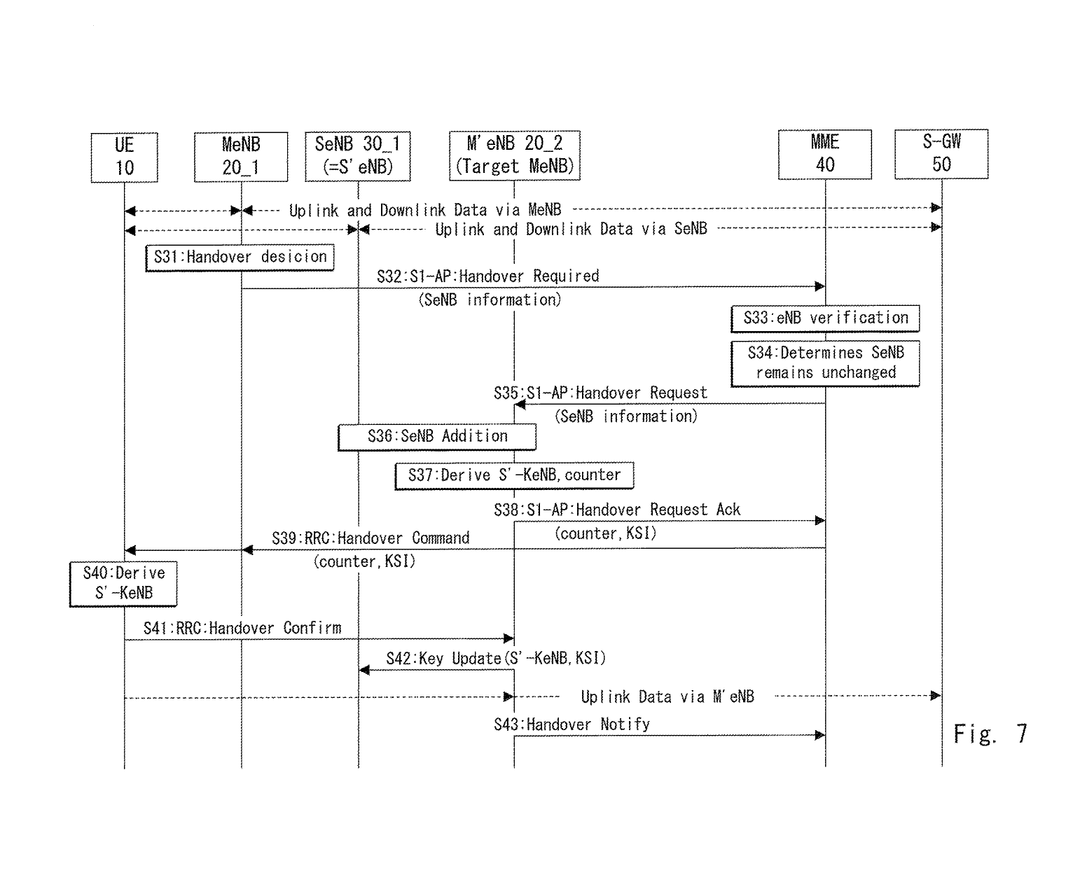

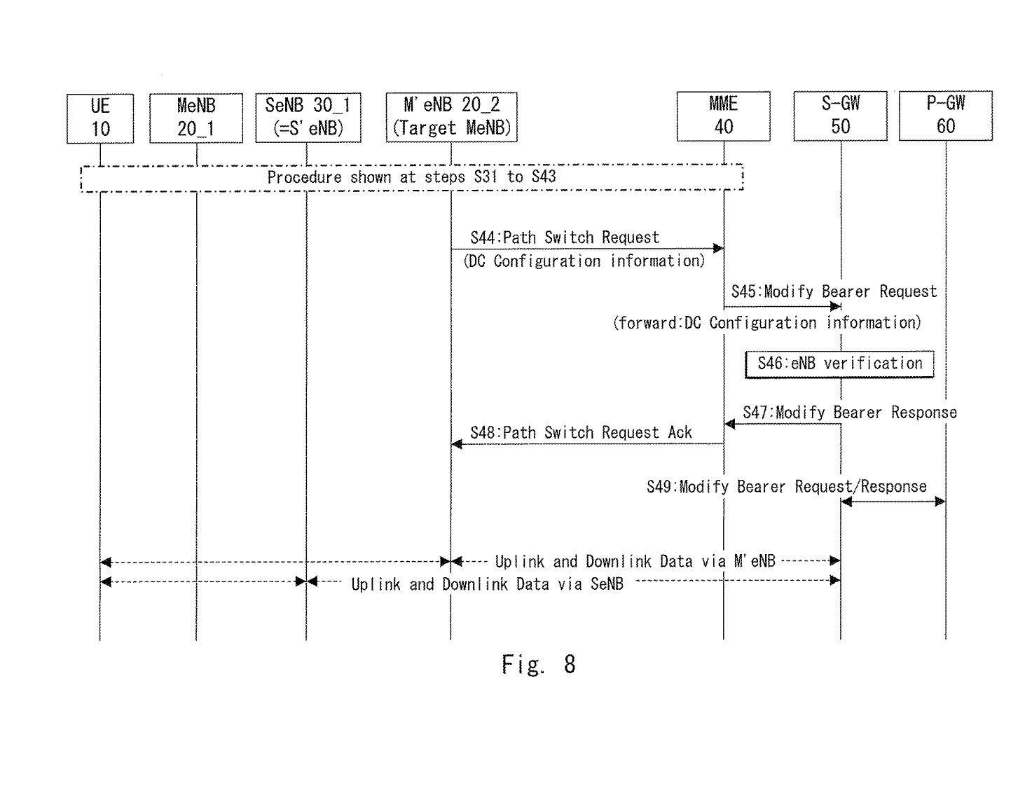

Next, there will be described operation examples of this exemplary embodiment with reference to FIGS. 7 and 8.

As shown in FIG. 7, the MeNB 20_1 makes decision for the handover (step S31), and includes information (hereinafter, sometimes referred to as “SeNB information”) on the SeNB 30_1 in an S1-AP: Handover Required message to be transmitted to the MME 40 (step S32).

For example, the SeNB information includes an IP addresses, an identity, TEIDs, EPC Bearers IDs and/or the like, which are allocated to the SeNB 30_1.

Upon receiving the S1-AP: Handover Required message, the MME 40 performs call admission control (step S33). At this step S33, the MME 40 verifies whether the SeNB 30_1 can also be served by the M′eNB 20_2. When the MME 40 determines that the SeNB 30_1 remains unchanged (step S34), the MME 40 includes the SeNB information in an S1-AP: Handover Request message to be transmitted to the M′eNB 20_2 (step S35).

Upon receiving the S1-AP: Handover Request message, the M′eNB 20_2 verifies whether the M′eNB 20_2 can also serve the SeNB 30_1, and then performs a limited SeNB Addition (step S36). Specifically, the M′eNB 20_2 skips RRC configuration for the SeNB 30_1, because such RRC configuration has already been performed by the MeNB 20_1. Note that the Handover Request message may contain the Source SeNB ID, so that the Target MeNB 20_2 recognizes whether the source SeNB 30_1 may also be the Target SeNB.

Then, the M′eNB 20_2 derives a key S′-KeNB and a counter (step S37), and sends an S1-AP: Handover Request Ack message to the MME 40 (step S38). In this Handover Request Ack message, the M′eNB 20_2 provides the counter and a KSI. Moreover, the M′eNB 20_2 provides information indicating that the SeNB 30_1 will not change and the bearers currently served by the SeNB 30_1 will not be handed-over.

Upon receiving the S1-AP: Handover Request Ack message, the MME 40 forwards the counter and the KSI for key derivation to the UE 10. Specifically, the MME 40 includes the counter and the KSI in an RRC: Handover Command message to be transmitted to the UE 10 through the MeNB 20_1 (step S39). In this Handover Command message, the MME 40 provides information indicating that that the SeNB 30_1 will stay the same.

Once the MeNB 20_1 receives the Handover Command message, the MeNB 20_1 sends an SeNB Release Request message to the SeNB 30_1 to remove the relationship to the SeNB 30_1 for the UE 10.

On the other hand, since the UE 10 is handed-over to the M′eNB 20_2, K-eNB* should be used to derive a new S-KeNB. Therefore, the UE 10 derives the key S′-KeNB by using the received counter and KSI (step S40). Then, the UE 10 sends to the M′eNB 20_2 an RRC: Handover Confirm message indicating that the UE 10 tuned to the M′eNB 20_2 (step S41).

Upon receiving the RRC: Handover Confirm message, the M′eNB 20_2 sends to the SeNB 30_1 a Key Update message including the key S′-KeNB and the KSI (step S42). Moreover, the M′eNB 20_2 sends a Handover Notify message to the MME 40 (step S43).

Thus, uplink data from the UE 10 to the S-GW 50 can be transmitted through the M′eNB 20_2 and the SeNB 30_1 in parallel.

The UE 10 has now synchronized with the M′eNB 20_2 and the SeNB 30_1. Therefore, as shown in FIG. 8, the M′eNB 20_2 sends to the MME 40 a Path Switch Request message including DC configuration information, thereby requesting only for the bearers that should be handed-over to the M′eNB 20_2 (step S44).

The MME 40 forwards the DC configuration information in a Modify Bearer Request message to the S-GW 50 (step S45).

The GW 50 performs eNB verification (step S46) to:

1) verify whether the M′eNB 20_2 is allowed to configure the SeNB 30_1 for the given UE 10;

2) verify whether the SeNB 30_1 is a valid network element;

3) verify whether he SeNB 30_1 is authorized to provide dual connectivity; and

4) confirm whether this request message is a DoS (Disc operating System) attack.

Upon succeeding in the verification, the S-GW 50 sends a Modify Bearer Response message back to the MME 40 (step S47). Then, the MME 40 sends a Path Switch Request Ack message back to the M′eNB 20_2 (step S48). Moreover, the S-GW 50 sends/receives Modify Bearer Request/Response messages to/from the P-GW 60 (step S49).

Thus, downlink data from the S-GW 50 to the UE 10 can also be transmitted through the M′eNB 20_2 and the SeNB 30_1 in parallel.

As described above, in this exemplary embodiment, it is possible for the UE and the Target MeNB to derive the security key S′-KeNB during the handover procedure. In addition, since the RRC configuration for the Target SeNB is skipped, it is also possible to more reduce the time when the U-Plane communication is disrupted due to inter-MeNB handover, and to reduce signaling overhead between the Target MeNB and SeNB.

### Third Exemplary Embodiment

A system according to this exemplary embodiment can be configured in a similar manner to that shown in FIG. 1 in the first exemplary embodiment.

Meanwhile, this exemplary embodiment is different from the first and second exemplary embodiments in treating the above-mentioned scenario 3.

In this scenario, the MeNB 20_1 performs SeNB Release and after the handover is completed, M′eNB 20_2 will configure a new SeNB by performing SeNB Addition.

Therefore, in this exemplary embodiment, the following matters (1) to (4) will be required.

(1) The Source MeNB should release the SeNB before handover to the Target MeNB.

(2) The Target MeNB should configure a new SeNB after handover is completed.

(3) The SGW and the UE are informed for such change.

(4) Handover procedure should be updated accordingly.

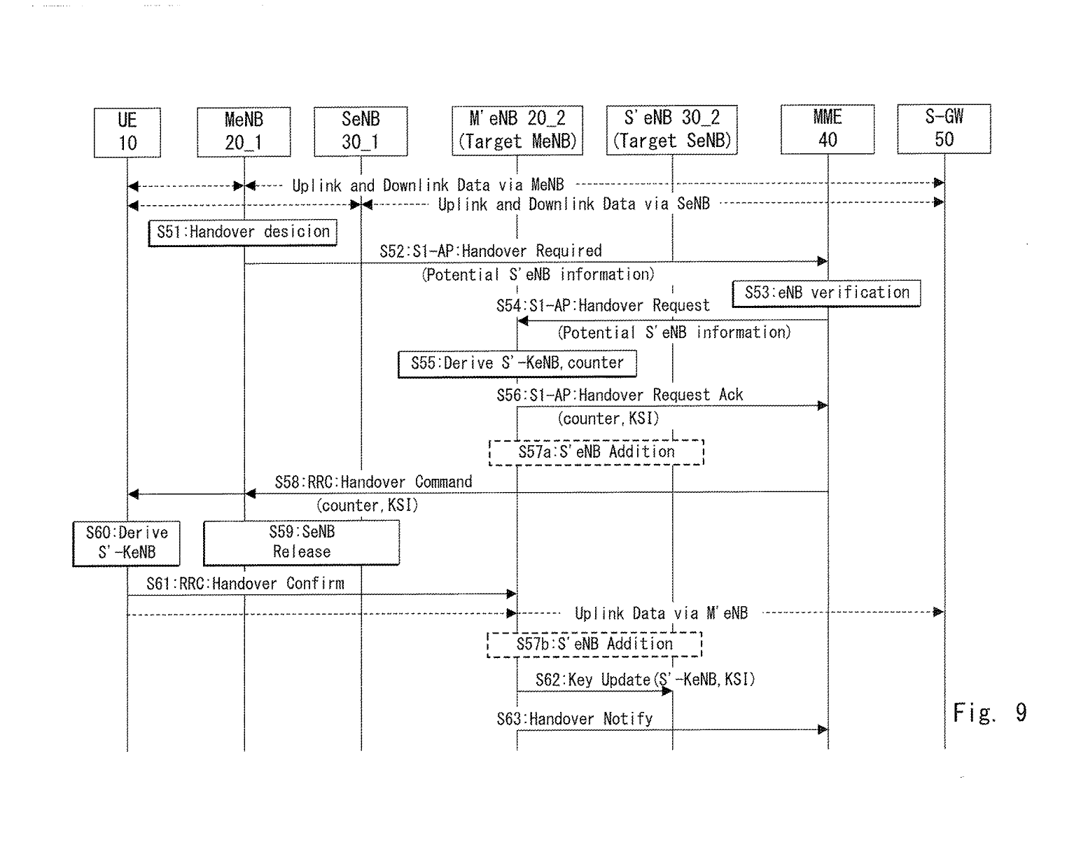

Next, there will be described operation examples of this exemplary embodiment with reference to FIG. 9.

As shown in FIG. 9, the MeNB 20_1 makes decision for the handover (step S51), and if available, includes Potential S′eNB information in a Handover Required message to be transmitted to the MME 40 (step S52).

Upon receiving the S1-AP: Handover Required message, the MME 40 performs call admission control for verifying the Source MeNB 20_1 and SeNB 30_1 as well as the Target MeNB 20_2 and SeNB 30_2 (step S53).

Then, the MME 40 includes the Potential S′eNB information in an S1-AP: Handover Request message to be transmitted to the M′eNB 20_2 (step S54).

Upon receiving the S1-AP: Handover Request message, the M′eNB 20_2 selects the S′eNB 30_2 based on the Potential S′eNB, or confirms the S′eNB 30_2 proposed by the MME 40. Moreover, the M′eNB 20_2 derives a key S′-KeNB and a counter (step S55).

Then, the M′eNB 20_2 sends an S1-AP: Handover Request Ack message to the MME 40 (step S56). In this Handover Request Ack message, the M′eNB 20_2 provides the counter and a KSI.

Further, the M′eNB 20_2 may check with the S′eNB 30_2 about available resources, and may start already a simplified S′eNB addition procedure, i.e., only messages between the target MeNB 20_2 and SeNB 30_2 would be send (step S57a). The RRC connection modification to the UE 10 cannot be sent at this stage, since the UE 10 still attaches to the Source MeNB 20_1.

Upon receiving the S1-AP: Handover Request Ack message, the MME 40 includes the counter and the KSI in an RRC: Handover Command message to be transmitted to the UE 10 through the MeNB 20_1, thereby forwarding the counter and the KSI for key derivation to the UE 10 (step S58).

Once the MeNB 20_1 receives the Handover Command message, the MeNB 20_1 performs the SeNB Release procedure to remove the relationship to the SeNB 30_1 for the UE 10 (step S59).

On the other hand, since the UE 10 is handed-over to the M′eNB 20_2 and the S′eNB 30_2, the UE 10 derives the key S′-KeNB by using the received counter and KSI (step S60). Then, the UE 10 sends to the M′eNB 20_2 an RRC: Handover Confirm message indicating that the UE 10 tuned to the M′eNB 20_2 (step S61).

Upon receiving the RRC: Handover Confirm message, the M′eNB 20_2 may perform the RRC connection reconfiguration (step S57b).

Further, the M′eNB 20_2 sends to the S′eNB 30_2 a Key Update message including the key S′-KeNB and the KSI (step S62). Moreover, the M′eNB 20_2 sends a Handover Notify message to the MME 40 (step S63).

Thus, uplink data from the UE 10 to the S-GW 50 can be transmitted through the M′eNB 20_2 and the S′eNB 30_2 in parallel.

After that, the procedure show in FIG. 4 is performed. Thus, downlink data from the S-GW 50 to the UE 10 can also be transmitted through the M′eNB 20_2 and the S′eNB 30_2 in parallel.

Note that the MeNB 20_1 may trigger the Modify Bearer Request message at a later stage in a case where the SeNB 30_1 performs data forwarding. For example when the M′eNB 20_2 receives the Path Switch Request Ack message, the S-GW 50 could provide an end marker to the SeNB 30_1 as well to indicate the end of the data forwarding.

S′eNB Addition is performed before Path Switch and Modify Bearer procedure such that the procedures for both handover and S′eNB Addition can be combined in one to reduce signaling. At this stage, the S′eNB addition procedure should do the RRC connection modification to enable the UE 10 to sync on the S′eNB 30_2. The Path Switch/Modify Bearer message to the MME/SGW contains the downlink TEIDs for the bearers at the Target MeNB 20_2 and the Target SeNB 30_2.

As described above, in this exemplary embodiment, it is possible for the UE and the Target MeNB to derive the security key S′-KeNB during the handover procedure. Further, it is possible to inform the UE and the S-GW to stop sending packets via the source SeNB. Furthermore, it is possible to inform the MME and the S-GW that new Target SeNB is configured.

In addition, it is possible to quickly complete the configuration for the Target SeNB, compared with e.g., a case where after the handover procedure is completed, such a configuration is started in a similar manner to the typical initial SeNB configuration. This is because even when configuring a new SeNB after handover is completed, the Target MeNB can preliminarily prepare for configuring the new SeNB during the handover procedure. Thus, as with the first exemplary embodiment, it is also possible to reduce the time when the U-Plane communication is disrupted due to inter-MeNB handover.

Next, configuration examples of the UE 10, the Source MeNB 20_1, the Target MeNB 20_2 and the MME 40 common to the first to third exemplary embodiments, will be subsequently described with reference to FIGS. 10 to 13.

As shown in FIG. 10, the UE 10 includes a reception unit 11 and a derivation unit 12. The derivation unit 11 receives the RRC: Handover Command message from the MME 40 through the Source MeNB 20_1. The derivation unit 12 derives the key S′-KeNB by using the counter, the KSI and/or the like included in the RRC: Handover Command message. Note that the units 11 and 12 are mutually connected with each other thorough a bus or the like. These units 11 and 12 can be configured by, for example, an interface such as a transceiver which conducts radio communication with the MeNB and SeNB, and a controller such as a CPU (Central Processing Unit) which controls this interface to execute the processes shown in FIGS. 3, 4 and 7 to 9, or processes equivalent thereto.

Further, as shown in FIG. 11, the Source MeNB 20_1 includes a send unit 101 and a forward unit 102. The send unit 101 sends the S1-AP: Handover Required message including the Potential S′eNB information or the SeNB information to the MME 40. The forward unit 102 forwards the RRC: Handover Command message from the MME 40 to the UE 10, thereby forwarding the counter, the KSI, and/or the RRC configuration information to the UE 10. Note that the units 101 and 102 are mutually connected with each other thorough a bus or the like. These units 101 and 102 can be configured by, for example, an interface such as a transceiver which conducts radio communication with the UE, an interface such as a transceiver which conducts communication with the SeNB, MME and S-GW, and a controller such as a CPU which controls these interfaces to execute the processes shown in FIGS. 3, 4 and 7 to 9, or processes equivalent thereto.

Further, as shown in FIG. 12, the Target MeNB 20_2 includes a reception unit 201, configuration unit 202, derivation unit 203 and a send unit 204. The reception unit 201 receives the S1-AP: Handover Request message from the MME 40. The configuration unit 202 configures the SeNB 30_2 or 30_1 based on the Potential S′eNB information or the SeNB information included in the S1-AP: Handover Request message. The derivation unit 203 derives the key S′-KeNB and the counter, and distributes the Key Update message including the key S′-KeNB and the KSI to the SeNB 30_2 or 30_1. The send unit 204 sends the S1-AP: Handover Request Ack message to the MME 40, thereby sending the counter, the KSI, and/or the RRC configuration information to the MME 40. Moreover, the send unit 204 sends the Path Switch Request message including the DC configuration information to the MME 40, thereby sending the DC configuration information to the S-GW 60. Note that the units 201 to 204 are mutually connected with each other thorough a bus or the like. These units 201 to 204 can be configured by, for example, an interface such as a transceiver which conducts radio communication with the UE, an interface such as a transceiver which conducts communication with the SeNB, MME and S-GW, and a controller such as a CPU which controls these interfaces to execute the processes shown in FIGS. 3, 4 and 7 to 9, or processes equivalent thereto.

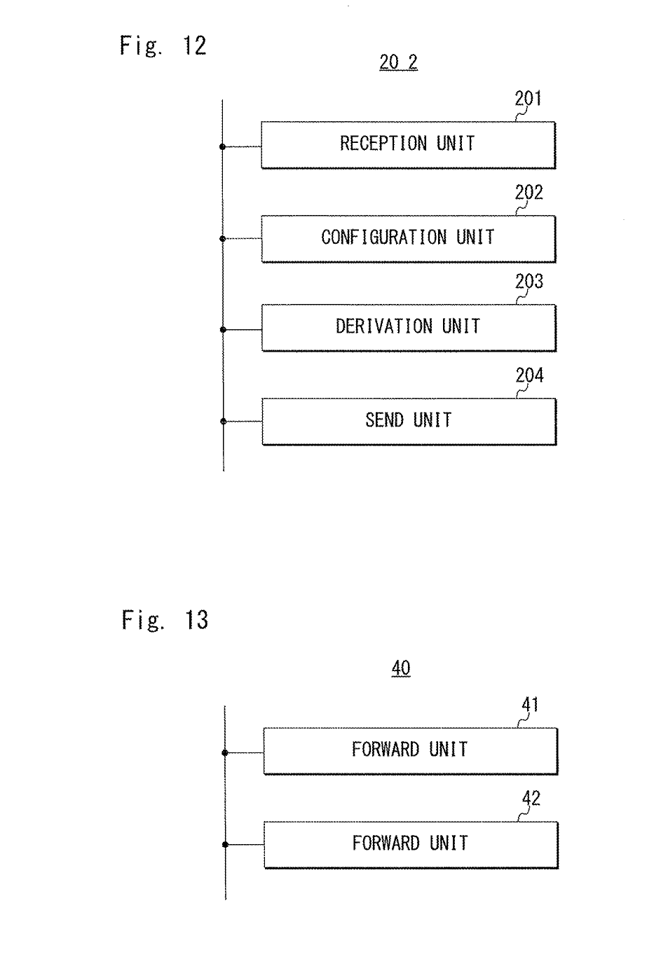

Furthermore, as shown in FIG. 13, the MME 40 includes forward units 41 and 42. The forward unit 41 forwards the Potential S′eNB information or the SeNB information from the Source MeNB 20_1 to the Target MeNB 20_2, by using S1-AP: Handover Required message and the S1-AP: Handover Request message. The forward unit 42 forwards the counter, the KSI, and/or the RRC configuration information from the Target MeNB 20_2 to the UE 10 through the Source MeNB 20_1, by using the S1-AP: Handover Request Ack message and the RRC: Handover Command message. Note that the units 41 and 42 are mutually connected with each other thorough a bus or the like. These units 41 and 42 can be configured by, for example, an interface such as a transceiver which conducts communication with the MeNB and the S-GW, and a controller such as a CPU which controls this interface to execute the processes shown in FIGS. 3, 4 and 7 to 9, or processes equivalent thereto.

Note that the present invention is not limited to the above-mentioned exemplary embodiments, and it is obvious that various modifications can be made by those of ordinary skill in the art based on the recitation of the claims. For example, the above-mentioned exemplary embodiments may be utilized in combination.

The whole or part of the exemplary embodiments disclosed above can be described as, but not limited to, the following supplementary notes.

(Supplementary Note 1 for the First Exemplary Embodiment)

Source MeNB provides Source SeNB and Target SeNB information to the MME, by sending “S1-AP: Handover Request” message.

Target MeNB provides relevant Target SeNB RRC information to the MME.

MME provides relevant Target SeNB RRC information in the Handover Command.

Security key derivation in the Target MeNB and distribution to the Target SeNB.

Target MeNB sends counter and KSI to UE via MME in “S1-AP: Handover Request Ack” message.

Merged Modify Bearer procedure for all bearers to two different destinations (Target MeNB and Target SeNB).

(Supplementary Note 2 for the Second Exemplary Embodiment)

Source MeNB provides Source SeNB and Target SeNB information to the MME.

MME performs admission control for the Target SeNB.

Security key derivation in the Target MeNB and distribution to the Target SeNB.

Target MeNB sends counter and KSI to UE via MME in “S1-AP: Handover Request Ack” message.

Merged Modify Bearer procedure for all bearers to two different destinations (Target MeNB and Target SeNB).

(Supplementary Note 3 for the Third Exemplary Embodiment)

Source MeNB provides Source SeNB and Target SeNB information to the MME.

Target MeNB provides relevant Target SeNB RRC information to the MME.

Target MeNB sends counter and KSI to UE via MME in “S1-AP: Handover Request Ack” message.

Security key derivation in the Target MeNB and distribution to the Target SeNB.

Merged Modify Bearer procedure for all bearers to two different destinations (Target MeNB and Target SeNB).

This application is based upon and claims the benefit of priority from Japanese patent application No. 2014-191573 filed on Sep. 19, 2014, the disclosure of which is incorporated herein in its entirety by reference.

### REFERENCE SIGNS LIST

10 UE
11, 201 RECEPTION UNIT
12, 203 DERIVATION UNIT
20_1, 20_2 MeNB
30_1, 30_2 SeNB
40 MME
41, 42, 102 FORWARD UNIT
50 S-GW
60 P-GW
101, 204 SEND UNIT
202 CONFIGURATION UNIT

1. A UE (User Equipment) comprising:
a receiver configured to receive, from an MME (Mobility Management Entity) through an MeNB (Master eNB (evolved Node B)) to which the UE currently attaches for dual connectivity, a command to handover the UE to a different MeNB; and
a processor configured to derive, by use of parameters included in the command, a security key that is used for securely communicating for the dual connectivity with an SeNB (Secondary eNB) under control of the different MeNB.

2. The UE according to claim 1, wherein the parameters include a counter and a KSI (Key Set Identifier).

3. The UE according to claim 1, wherein the receiver receives, as the command, an RRC (Radio Resource Control): Handover Command message.

4. An MeNB that controls an SeNB to provide dual connectivity for a UE, the MeNB comprising:
a transmitter configured to send to an MME, upon requesting the MME to handover the UE to a different MeNB, first information on one or more SeNBs that are candidates available for the dual connectivity under control of the different MeNB.

5. (canceled)

6. The MeNB according to claim 4,
wherein the transmitter forwards, from the MME to the UE, parameters necessary for the UE to derive a security key being used for securely communicating with an SeNB under control of the different MeNB.

7. The MeNB according to claim 6, wherein the transmitter forwards an RRC: Handover Command message including the parameters.

8. The MeNB according to claim 4, wherein the transmitter forwards, from the MME to the UE, parameters necessary for the UE to derive a security key being used for securely communicating with an SeNB under control of the different MeNB, and second information on RRC configuration for the SeNB.

9. (canceled)

10. The MeNB according to claim 6, wherein the parameters include a counter and a KSI.

11. The MeNB according to claim 4, wherein the transmitter uses, upon the sending, an S1-AP (S1 Application Protocol): Handover Required message.

12. An MeNB comprising:
a receiver configured to receive from an MME, upon being requested by the MME to handover a UE from a different MeNB to the MeNB itself, first information on one or more SeNBs that are candidates available for providing dual connectivity for the UE; and
a processor configured to configure a SeNB that is selected based on the first information to provide the dual connectivity.

13. (canceled)

14. The MeNB according to claim 12 wherein the processor derives a security key that is used for the SeNB to securely communicate with the UE, and for distributing the security key to the SeNB.

15. The MeNB according to claim 14, further comprising:
a transmitter configured to send, to the MME, parameters necessary for the UE to derive the security key.

16. The MeNB according to claim 15, wherein the transmitter uses, upon the sending, an S1-AP: Handover Request Ack message.

17. The MeNB according to claim 12, further comprising:
a transmitter configured to send, to the MME, parameters necessary for the UE to derive a security key being used for securely communicating with the SeNB, and second information on RRC configuration for the SeNB.

18. The MeNB according to claim 17, wherein the transmitter uses, upon the sending, an S1-AP: Handover Request Ack message.

19. The MeNB according to claim 15, wherein the parameters include a counter and a KSI.

20. The MeNB according to claim 12, wherein the receiver receives an S1-AP: Handover Request message including the first information.

21. The MeNB according to claim 12, further comprising:
a transmitter configured to send, to an S-GW (Serving Gateway) through the MME, information on configuration for the dual connectivity.

22. An MME comprising:
a transmitter configured to forward to an MeNB, upon requesting the MeNB to handover a UE from a different MeNB to the MeNB, first information on one or more SeNBs that are candidates available for providing dual connectivity for the UE.

23. (canceled)

24. The MME according to claim 22 wherein the transmitter forwards, from the MeNB to the UE through the different MeNB, parameters necessary for the UE to derive a security key being used for securely communicating with an SeNB under control of the MeNB.

25. The MME according to claim 24, wherein the transmitter forwards an RRC: Handover Command message including the parameters.

26. The MME according to claim 22, wherein the transmitter forwards, from the MeNB to the UE through the different MeNB, parameters necessary for the UE to derive a security key being used for securely communicating with an SeNB under control of the MeNB, and second information on RRC configuration for the SeNB.

27. (canceled)

28. The MME according to claim 24, wherein the parameters include a counter and a KSI.

29. (canceled)
